(19) United States
(12) Patent Application Publication
(10) Pub. No.: US 2011/0137807 A1
(43) Pub. Date: Jun. 9, 2011

(54) MODEL-BASED CUSTOMIZED ECO SYSTEM AND DESIGN METHOD THEREOF

(75) Inventor: Jung Eun Cha, Daejeon (KR)

(73) Assignee: Electronics and Telecommunication Research Institute, Daejeon (KR)

(21) Appl. No.: 12/829,609

(22) Filed: Jul. 2, 2010

(30) Foreign Application Priority Data
Dec. 8, 2009 (KR) 10-2009-0121124

(51) Int. Cl. G06Q 50/00; G06Q 10/00; G06Q 99/00; G06F 9/44

(52) U.S. Cl. 705/300; 717/123

(57) ABSTRACT

A model-based customized eco system includes: a work distribution unit for managing a download of a developed work of an embedded software platform; a shared asset management unit for managing a users' upload of a modified version of the developed work; a user support unit for receiving users' opinions about the developed work; and a repository management unit for managing information on the users and the developed work.

### CROSS-REFERENCE(S) TO RELATED APPLICATION(S)

The present invention claims priority of Korean Patent Application No. 10-2009-0121124, filed on Dec. 8, 2009, which is incorporated herein by reference.

### FIELD OF THE INVENTION

The present invention relates to an eco system, and more specifically, to a model-based customized eco system and a design method thereof which can be naturally evolved and maintained among developers and users.

### BACKGROUND OF THE INVENTION

In an embedded system, various functions are required depending on a variety of devices, and most functions are based on open source software.

Since the completion rate or scopes of functions to be implemented can be changed according to developer's purpose or user's view, it is necessary to have a method capable of maximizing flexibility of development or user's utilization by providing a set of desired optimum functions that fully reflect user's feedbacks. For example, an eco system may be provided to accept feedbacks directly from the users and to make up for drawbacks of distributed works, thereby enlarging the satisfaction of users so as to result in continual and voluntary participation of users and, finally, the technical prosperity.

Such an eco system means a system that can build and evolve a natural win-win organization where all the related parties can get accomplishments through the voluntary participation of various developers and users. Therefore, the developers should build the eco system in order to distribute their works more easily while the users expect to get optimum services therefrom.

However, most of conventional eco systems are made within a simple user home page level due to their focuses on developer's building easiness, or are provided in the form of an open source software project maintained by user's voluntary participation. The first one is difficult to actively reflect user's opinion because it provides just a simple distribution function for developers; and the second one has a problem in its building costs resulted from such functions as being related with maintenance of a server or a community, security, verification, and the like.

In another view, though the eco system is a voluntary system maintained by developers and users, it has a lot of variables such as the kind of works to be spread or the range of users, or the like. Therefore, basic functions of the system, which both developers and users can approve, are fixed by developers in the early development time, and the rest need to be adjusted and confirmed while the eco system is being operated.

Since, however, most of the conventional eco systems provide only such services as being related with the basic function fixed early by the developers, the utilization of users is too much restricted, and a link to an external system or addition of functions requested by users, which can occur in the future, may be disabled or difficult.

### SUMMARY OF THE INVENTION

In view of the above, the present invention provides a model-based customized eco system capable of extending itself and linking to other systems at a model level, wherein the course of evolution (design modifications such as addition or reduction of functions) is decided according to user's feedbacks by the steps of: deciding scopes of functions required in the development of an eco system, according to development purposes; classifying the functions; suggesting a scenario for building an optimum function architecture; and defining a meta model of each function module.

Further, the present invention provides a model-based customized eco system capable of guaranteeing extension of itself and link to other systems, without errors, wherein the architecture of the eco system is made flexibly adjustable at a model level according to the views of developers and users in various embedded systems, which should be frequently changed or necessarily require user's participation.

In accordance with a first aspect of the present invention, there is provided a model-based customized eco system, including:

a work distribution unit for managing a download of a developed work of an embedded software platform;

a shared asset management unit for managing a users' upload of a modified version of the developed work;

a user support unit for receiving users' opinions about the developed work; and

a repository management unit for managing information on the users and the developed work.

In accordance with a second aspect of the present invention, there is provided a method for designing a model-based customized eco system, including:

managing information on a developed work of an embedded software platform;

distributing the developed work;

gathering opinions of users about the distributed developed work; and

improving the developed work by reflecting the gathered opinions.

### BRIEF DESCRIPTION OF THE DRAWINGS

The objects and features of the present invention will become apparent from the following description of embodiments given in conjunction with the accompanying drawings, in which:

FIG. 1 is a flow chart illustrating a process of deciding a scope of functions of an eco system in accordance with an embodiment of the present invention;

FIG. 2 shows a block diagram illustrating function stages provided by an eco system in accordance with the embodiment of the present invention;

FIG. 3 depicts a table illustrating services per a function stage of the eco system in accordance with the embodiment of the present invention;

FIG. 4 sets out a conceptual view illustrating a function lineup scenario of the eco system in accordance with the embodiment of the present invention;

FIG. 5 provides an architecture view illustrating the eco system in accordance with the embodiment of the present invention; and

FIG. 6 is a class diagram illustrating a common design template of the eco system in accordance with the embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

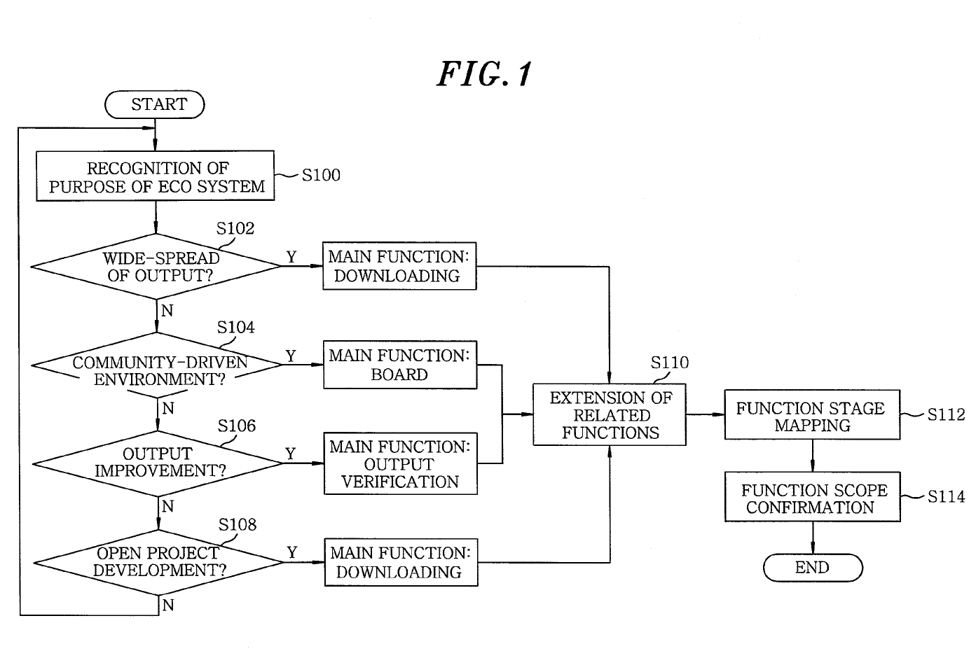

FIG. 1 is a flow chart illustrating a process of deciding a scope of functions of an eco system in accordance with an embodiment of the present invention.

The scope of functions of the eco system is determined according to building purposes of the eco system by developers in the early development time, and may be gradually changed according to the intentions of participating users and operation purpose of the eco system.

Referring to FIG. 1, the purpose of the eco system should be recognized before anything else to build the initial stage of the eco system, in step S100. In this embodiment, there are four purposes exemplified, including a wide-spread of output in step S102, a community-driven environment in step S104, an improvement of output in step S106, and an open project development (or voluntary improvement) in step S108.

Based on each purpose, a main function is defined as ‘Downloading’ for both purposes of the wide-spread of output in step S102 and the open project development in step S108, ‘Board’ for the purpose of the community-driven environment in step S104, and ‘Output Verification’ (or ‘Source Verification’) for the purpose of the improvement of output (the developed works) in step S106. Then, related functions accompanied by the main functions are extended in step S110, and final scopes of functions are confirmed in step S114 through a function stage mapping S112.

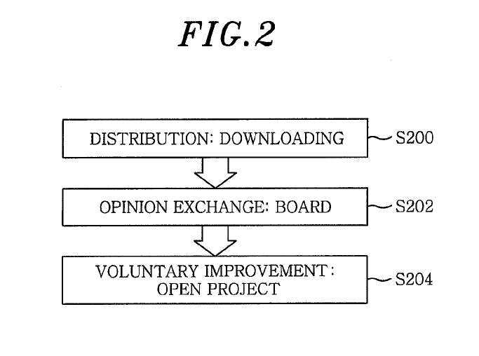

FIG. 2 shows a block diagram illustrating the ‘function stages’, which is mentioned in step S112 of FIG. 1, provided in an eco system in accordance with the embodiment of the present invention. The ‘function stages’ support a detailed confirmation for the eco system service functions included in each step by mapping the scopes of functions, under the status extended to the related functions, with abstracted function groups.

Referring to FIG. 2, the ‘function stages’ sequentially include three stages of distribution S200, opinion exchange S202 and voluntary improvement S204. In the distribution stage S200, easy accessing/downloading functions and user management functions are provided as main services for the purpose of wide-spread of released files. This may be enabled by making up for a function of homepage being currently operated.

In the opinion exchange stage S202, a bulletin board function is a main service to enable the exchange of opinions among developers and users. Herein, basic tools are provided, with which main progresses of projects are posted in view of the developers, various opinions are exchanged about products, technologies, and operating methods, and users can make voluntary co-documents. Further, those functions capable of retrieving shared codes already released, providing suitable meta information about them, and managing version thereof are supported. Most of all, it is important to activate a community of sharing each other's knowledge by introducing such an idea of ‘a question and answer corner’ used in a portal site.

The voluntary improvement stage S204 includes a series of services by which the users can modify, improve, and again share the released files. Therefore, it is important to provide those functions of source code review and version management of the source code so as to upload and share programs developed by users. Further, an issue tracker is necessarily required to track and settle down various issues, and plug-in or open API may be necessary for interworking with related services.

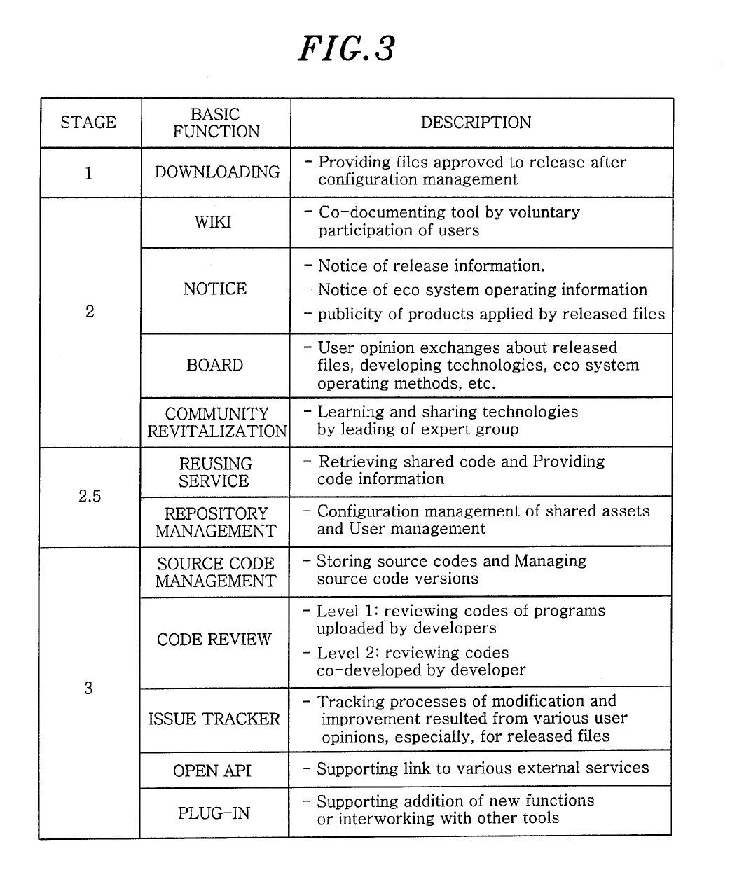

FIG. 3 illustrates a table for classifying the main functions of the eco system confirmed through the procedures of FIGS. 1 and 2 in accordance with the embodiment of the present invention. As shown, the function stages of FIG. 2 defined according to the system purposes of FIG. 1 are mapped with specific function services of FIG. 3.

Herein, the aforementioned functions of the eco system are organized and classified into a basic group and an optional group so as to gradually build an eco system according to the development purpose.

That is to say, the functions are separated into stages 1 to 3 according to the development purpose. Thereafter, the functions are classified as either a basic compulsory function or an optional correctable function in each stage and then those classified functions are combined to organize a single design scenario.

For example, the main function of the stage 1 is ‘Downloading’, which enables users to download work files such as the embedded software platform developed by developers.

The main functions of the stage 2 are ‘Wiki’, ‘Notice’, ‘Board’, and ‘Community Revitalization’. ‘Wiki’ is a function for a real time co-documenting tool; ‘Notice’, for noticing major progresses related with a released work; ‘Board’, for exchanging of opinions among users about released products, developing technologies, and eco system operating methods; and ‘Community Revitalization’, for sharing knowledge with each other through the leading of an expert group composed of a professional engineer, a program developer, or the like.

The main functions of the stage 2.5 are ‘Reusing Service’ and ‘Repository Management’, wherein the first one means a function of enabling users to retrieve shared codes and provide meta information and the second one means a function for shared asset configuration management and user management.

The main functions of stage 3 are ‘Source Code Management’, ‘Code Review’, ‘Issue Tracker’, ‘Open API’, and ‘Plug-in’. ‘Source Code Management’ is a function for storing source codes and managing versions thereof; ‘Code Review’, for reviewing codes of developer-uploading programs or those resulted from the co-works among developers; ‘Issue Tracker’, for managements such as tracking, retrieval, and person-in-charge allocation for bugs of the released works and user requests, or for opinion exchanges in association with the bulletin board; ‘Open API’, for linking to various external services; and ‘Plug-in’, for adding new functions or interworking with other tools.

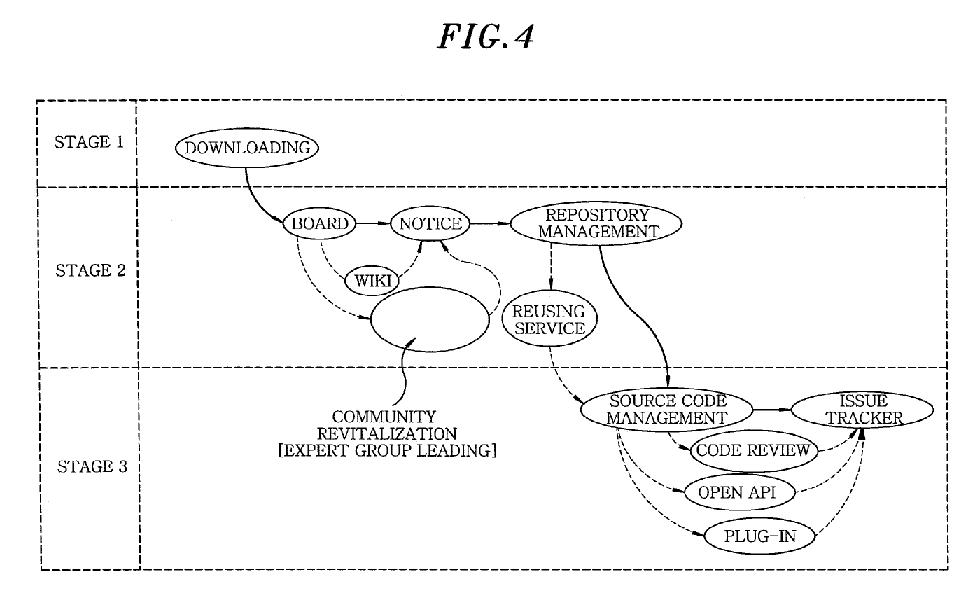

FIG. 4 sets out a conceptual view illustrating a function lineup scenario for building the eco system in accordance with the embodiment of the present invention, wherein solid lines show the connections of basic functions while dotted lines show those of optional functions.

In case of building an eco system of stage 3, developers must make the system include: the basic function ‘Downloading’ of stage 1; the basic functions ‘Board’, ‘Notice’, and ‘Repository Management’ of stage 2; and the basic functions ‘Source Code Management’ and ‘Issue Tracker’ of stage 3.

The eco system may additionally include optional functions in stage 2, i.e., ‘Wiki’ as a user co-documenting function, ‘Community Revitalization’ as a knowledge sharing function by experts, or ‘Reusing Service’ for the shared asset (or common source) managed by the eco system, according to the range of users and the utilization methods of the eco system.

Also, the eco system may additionally include optional functions in stage 3, i.e., ‘Code Review’ for the developer-uploading programs or the co-works among developers, ‘Open API’ for linking to various external services, and ‘Plug-in’ for adding new functions or interworking with another tools.

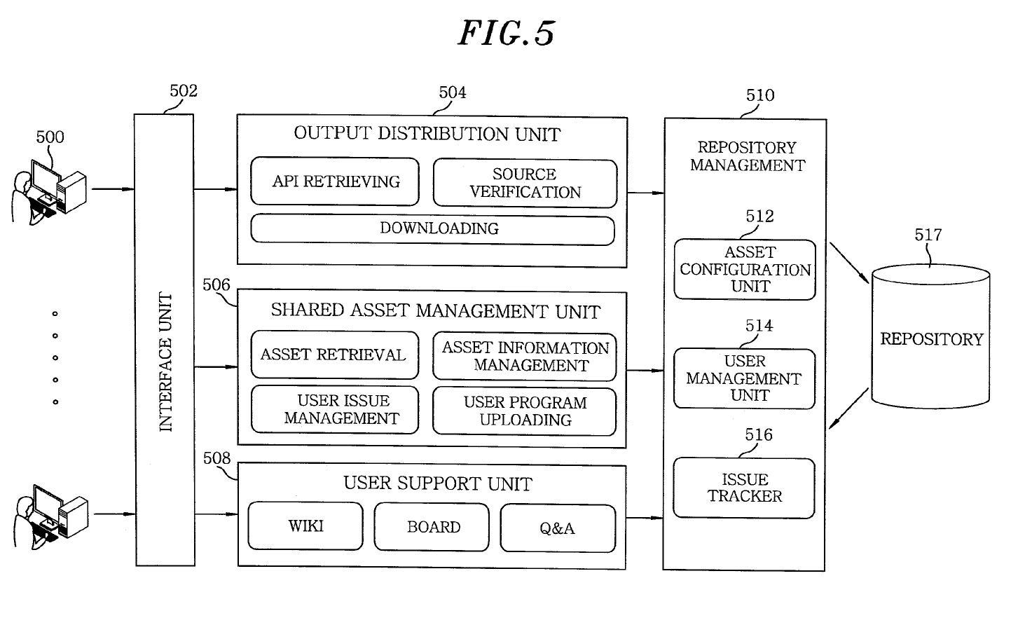

Based on the aforementioned function architecture of the eco system, a common meta model can be provided. To this end, first, a common architecture of the eco system will be defined with reference to FIG. 5.

FIG. 5 provides a view illustrating a common architecture of the model-based customized eco system in accordance with the embodiment of the present invention.

Referring to FIG. 5, the eco system includes: a work distribution unit 504 for distributing developed works such as embedded software platforms to users; a shared asset management unit 506 for performing a voluntary reuse of the developed works; a user support unit 508 for gathering and reflecting user's opinions about the distributed works; and a repository management unit 510 for managing information on the developed works.

The work distribution unit 504 enables a plurality of users 500, who access the eco system via a network such as Internet, to download the developed works such as the embedded software platforms through an interface unit 502. Further, it performs API test or source verification for the developed works.

The shared asset management unit 506 stores, retrieves, and manages the works constituting various embedded software platforms, the information thereof, and users' access information with respect to the embedded software platforms. Further, the shared asset management unit 506 enables the users to upload a modified version of the developed works. The user support unit 508 provides such functions as Wiki, Board, and Q&A that enable exchanges of opinions among users, so that a plurality of users who download the developed embedded software platforms can express their opinions about the platform and those opinions can be reflected for the improvement of the platform.

The repository management unit 510 stores all the works and information managed by the eco system in a repository 517, updates them, and maintains openness thereof.

An asset configuration unit 512 manages source codes and version information of the developed works such as embedded software platforms. A user management unit 514 manages information on users who download the developed work or offer opinions thereabout.

The issue tracker 516 reflects improvements of the developed work.

In detail, the issue tracker 516 collects opinions of various users about the developed works such as embedded software platforms from the user support unit 508, catches bugs and requests for modification of the developed works, and make the bugs and requests be reflected when a corresponding developed work is modified. Further, it makes the embedded software platforms be linked with an external service by applying an open API thereto, or enable the platforms to be added by new functions or be interworked with another tools by applying plug-in.

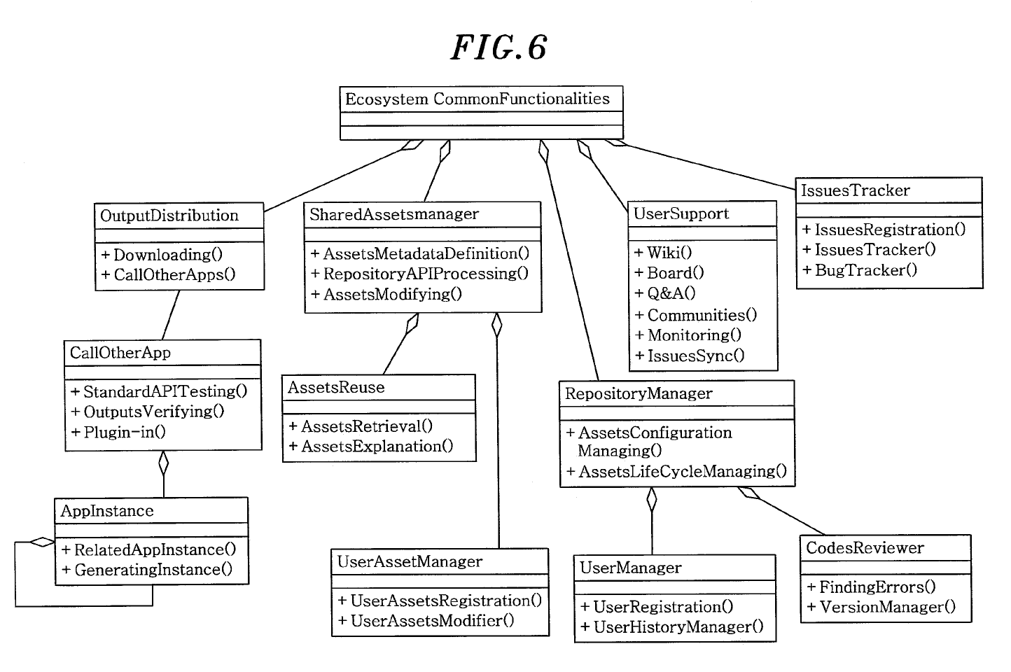

FIG. 6 illustrates methods of defining a common meta model and constructing a design template for applying the organized common function architecture of the eco system, shown in FIGS. 1 to 5, to a real design work.

Referring to FIG. 6, the template is designed in such a way that a meta model which defines common functions required in the eco system includes such functions as the output (developed work) distribution, the shared asset management, the user support, and the issue tracker and, in the lower level stages, optionally includes the other functions needed in the eco system.

At this point, an UML-based meta model can build a flexible eco system by adjusting core attributes in each function module as well as selecting each function module.

The model-based customized eco system and design method thereof have an advantage in enhancing the efficiency of a system development, by organizing an optimum eco system suitable for the purposes and strategies of developers using a common design template, which is composed of meta models that define a function classification depending on the purposes of the eco system, a function design scenario, and function modules.

Further, it has another advantage in maximizing the efficiency and flexibility of the eco system as well as the spread and improvement of the distributed works via the eco system, because it can be voluntarily evolved to have versatile functions according to patterns of accessing the eco system and varying requests of users, by using the meta models. That is to say, the architecture of the eco system is made flexibly adjustable at a model level according to the views of developers and users in various embedded systems, which should be frequently changed or necessarily require user's participation, thereby guaranteeing efficient development, and errorless extension and link of the eco system.

While the invention has been shown and described with respect to the preferred embodiments, it will be understood by those skilled in the art that various changes and modifications may be made without departing from the scope of the invention as defined in the following claims.

What is claimed is:

1. A model-based customized eco system, comprising:
a work distribution unit for managing a download of a developed work of an embedded software platform;
a shared asset management unit for managing a users' upload of a modified version of the developed work;
a user support unit for receiving users' opinions about the developed work; and
a repository management unit for managing information on the users and the developed work.

2. The system of claim 1, wherein the work distribution unit further performs an API test or a source verification for the developed work.

3. The system of claim 1, wherein the shared asset management unit further manages information on user's retrieval and access for the developed work.

4. The system of claim 1, wherein the user support unit posts the developed work on an open place, gathers users' opinion about an improvement of the developed work, and makes the opinion be reflected in the modified version of the developed work.

5. The system of claim 4, wherein the open place is a bulletin board of a community.

6. The system of claim 1, wherein the user support unit gathers an opinion about the developed work from an expert group and makes the opinion be reflected in the modified version of the developed work.

7. The system of claim 6, wherein the expert group is composed of those selected among a plurality of developers who develop the embedded software platform.

8. The system of claim 1, wherein the repository management unit includes:
an asset configuration unit for managing a source code and a version information of the developed work;
a user management unit for managing information on the users; and
an issue tracker for reflecting an improvement in the developed work.

9. The system of claim 8, wherein the issue tracker collects the opinions of the users and arranges bugs or requested items for amendment of the developed work.

10. The system of claim 8, wherein the issue tracker makes the developed work be linked with an external service by applying an open API to the developed work.

11. The system of claim 8, wherein the issue tracker makes the developed work to interwork with other tools by applying a plug-in to the developed work.

12. A method for designing a model-based customized eco system, comprising:
managing information on a developed work of an embedded software platform;
distributing the developed work;
gathering opinions of users about the distributed developed work; and
improving the developed work by reflecting the gathered opinions.

13. The method of claim 12, wherein said gathering opinions of users includes:
posting the developed work on an open place for the users; and
gathering opinions, being exchanged among the users, about the developed work.

14. The method of claim 13, wherein said gathering opinions of users further includes gathering opinions of an expert group about the developed work.

15. The method of claim 14, wherein the expert group is composed of those selected among a plurality of developers who develop the embedded software platform.

16. The method of claim 12, wherein said improving the developed work includes:
performing a code review of the developed work via a cooperation between the users and developers;
performing a code review of the developed work via a cooperation of an expert group; and
improving the developed work by the cooperation.

17. The method of claim 16, wherein the developed work is linked with an external service by applying an open API thereto, in said improving the developed work.

18. The method of claim 16, wherein the developed work is interworked with other tools by applying a plug-in thereto, in said improving the developed work.

19. The method of claim 12, wherein source codes and version information of the developed work are managed, in said managing information.

20. The method of claim 12, wherein information on user's retrieval and access for the developed work is managed, in said managing information.
